(19) United States
(12) Patent Application Publication
(10) Pub. No.: US 2025/0231723 A1
(43) Pub. Date: Jul. 17, 2025

(54) INFORMATION PROCESSING DEVICE USING DEFAULT PRINT SETTING STORED ON PRINTER ACCORDING TO SUPPORT PROGRAM

(71) Applicant: BROTHER KOGYO KABUSHIKI KAISHA, Nagoya (JP)

(72) Inventors: Airi EGUCHI, Ichinomiya (JP); Yoshito Hosomizo, Konan (JP); Kenju Narita, Nagoya (JP)

(21) Appl. No.: 19/015,048

(22) Filed: Jan. 9, 2025

(30) Foreign Application Priority Data
Jan. 17, 2024 (JP) 2024-005051

(51) Int. Cl. G06F 3/12

(52) U.S. Cl. CPC G06F 3/1257; G06F 3/1205; G06F 3/1255

(57) ABSTRACT

A non-transitory computer-readable storage medium stores a support program for an information processing device communicable with a printer. The information processing device includes: a computer; and a memory. The memory is configured to store therein an editing application program and an operating system in which a general-purpose printing program is embedded. The support program corresponds to the printer and supports the general-purpose printing program. The support program, when executed by the computer, causes the information processing device to perform: when a selection instruction selecting the printer is issued from the editing application program to the general-purpose printing program: acquiring; and storing; and when using the default print setting: reading. The acquiring acquires a default print setting stored on the printer. The storing stores, as a cache default print setting, the default print setting in the memory. The reading reads, from the memory, the cache default print setting.

### REFERENCE TO RELATED APPLICATIONS

This application claims priority from Japanese Patent Application No. 2024-005051 filed on Jan. 17, 2024. The entire content of the priority application is incorporated herein by reference.

### BACKGROUND ART

In recent years, practical technologies have been developed for controlling printers without the use of a printer driver provided by a printer vendor. One such technology utilizes a general-purpose printing program as a part of the operating system (OS) as standard. With this technology, the OS, upon detecting a printer, associates the printer with the OS-standard general-purpose printing program. Thereafter, when a print instruction to that printer is received, the OS-standard general-purpose printing program generates print data without the need for a printer driver provided a vendor of that printer, and thus can control printing based on the print data.

Japanese Patent Application Publication No. 2022-144355 discloses one example of a technology related to an OS-standard general-purpose printing program. This technology includes a support program for supporting a general-purpose printing program. The support program is configured to acquire default print settings stored on a printer either when displaying an advanced print settings screen or when a reset button is operated in the advanced print settings screen and to reflect the default print settings in the advanced print settings screen.

### SUMMARY

However, communication with the printer can sometimes take time. If the support program acquires the default print settings stored on the printer when displaying the advanced print settings screen or when the reset button in the advanced print settings screen is operated, as described in Japanese Patent Application Publication No. 2022-144355, there may be some delay before the support program can reflect these default print settings in the advanced print settings screen. Therefore, this technology for using default print settings stored on a printer has room for improvement.

In order to attain the above and other objects, according to one aspect, the present disclosure provides a non-transitory computer-readable storage medium storing a support program for an information processing device communicable with a printer. The information processing device includes: a computer; and a memory. The memory is configured to store therein an editing application program and an operating system. A general-purpose printing program is embedded in the operating system. The support program corresponds to the printer and supports the general-purpose printing program. The support program, when executed by the computer, causes the information processing device to perform: when a selection instruction selecting the printer is issued from the editing application program to the general-purpose printing program: (a) acquiring; and (b) storing; and when using the default print setting: (c) reading. The (a) acquiring acquires, from the printer, a default print setting stored on the printer. The (b) storing stores, as a cache default print setting, the default print setting acquired in the (a) acquiring in the memory. The (c) reading reads, from the memory, the cache default print setting stored in the (b) storing.

The support program disclosed in this specification, when executed by a computer of an information processing device, causes the information processing device to perform, when a printer corresponding to the support program is selected in the editing application program: acquiring a default print setting stored on the printer; and storing the acquired default setting in a memory of the information processing device. Furthermore, the support program, when executed by the computer, causes the information processing device to perform, when the default print setting is used, reading the default print setting from the memory. As a result, it is highly likely that the default print setting stored on the printer can be used immediately.

An information processing device that has the support program installed thereon, a computer-readable storage medium storing therein the support program, a control method of implementing the functions of the support program, and a printing system including the information processing device that has the support program installed thereon and a printer are all novel and useful.

The technology disclosed in this specification facilitates an information processing device having an OS-standard general-purpose printing program installed thereon to use default print settings stored on a printer.

### BRIEF DESCRIPTION OF DRAWINGS

FIG. 1 is a block diagram illustrating an electrical configuration of a personal computer.

FIG. 2 is a sequence chart illustrating an example of a printer selection procedure.

FIG. 3 is an explanatory diagram illustrating an example of a print settings screen.

FIG. 4 is a sequence chart illustrating an example of a print settings configuration procedure.

FIG. 5 is an explanatory diagram illustrating an example of an advanced settings screen.

FIG. 6 is a sequence chart illustrating an example of a print execution procedure.

FIG. 7 is a sequence chart illustrating an example of an exclusive settings resolution procedure.

### DESCRIPTION

Below, a personal computer (hereinafter referred to as “PC”) using a support program according to one embodiment will be described while referring to the accompanying drawings. This specification describes the support program executed on the PC. Note that the support program can be run on smartphones and mobile devices, as well as PCs.

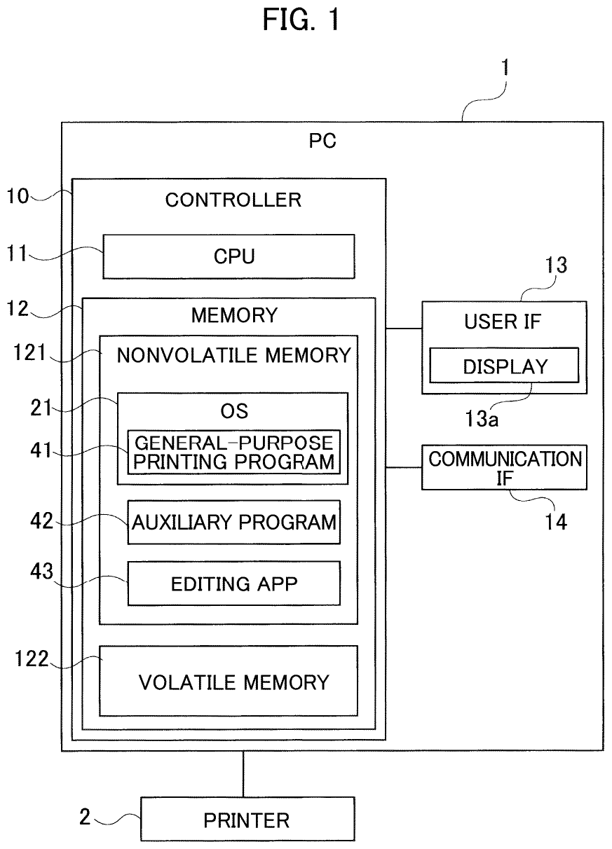

As illustrated in FIG. 1, the PC 1 of the present embodiment includes a controller 10 that includes a CPU 11 and a memory 12. The PC 1 is an example of the information processing device of the present disclosure. The CPU 11 is an example of the computer of the present disclosure. The PC 1 also includes a user interface (also described as “user IF”) 13 and a communication interface (also described as “communication IF”) 14, both of which are electrically connected to the controller 10. Note that the controller 10 in FIG. 1 is a general concept that covers all hardware and software used for controlling the PC 1 and is not actually limited to representing a single piece of hardware present in the PC 1.

The CPU 11 of the PC 1 executes various processes according to programs read from the memory 12 or based on user operations. The memory 12 includes nonvolatile memory 121 and volatile memory 122. The volatile memory 122 is used as a work area for executing various programs, for example. A buffer provided in the CPU 11 is also one example of the memory 12. Examples of the memory 12 may be a ROM, a RAM, a hard disk drive, or the like built into the PC 1 or may be any storage medium that is readable and writable by the CPU 11, such as a CD-ROM, a DVD-ROM, or other storage media.

The user interface 13 includes hardware that displays screens for reporting information to the user, and specifically a display 13a, and hardware that receives user operations. The user interface 13 may be a set of devices that includes the display 13a for displaying information, and a mouse, keyboard, and the like having input-receiving functions. Alternatively, the user interface 13 may be a touchscreen having both the function of the display 13a and an input-receiving function. The user interface 13 is an example of the user interface of the present disclosure.

The communication interface 14 includes hardware for communicating with external devices such as a printer 2. The communication standard employed by the communication interface 14 may be Ethernet (registered trademark), Wi-Fi (registered trademark), Universal Serial Bus (USB), or the like. “Ethernet” is a Japanese registered trademark of FUJIFILM Business Innovation Corp. “Wi-Fi” is a registered trademark of Wi-Fi Alliance. The PC 1 may be capable of connecting to the Internet via the communication interface 14. Alternatively, the PC 1 may include a plurality of communication interfaces 14 supporting a plurality of communication standards.

As illustrated in FIG. 1, the nonvolatile memory 121 of the memory 12 stores various programs and various data including an operating system (hereinafter referred to as “OS”) 21, an auxiliary program 42, and an editing application program (hereinafter referred to as “editing app”) 43. The OS 21 includes a general-purpose printing program (universal printing program, or generic program) 41. The auxiliary program 42 is an example of the support program of the present disclosure. The editing app 43 is an example of the editing application program of the present disclosure.

The OS 21 is a multitasking OS capable of concurrently processing a plurality of tasks by managing and switching between the tasks. The OS 21 is one of Windows (registered trademark), macOS (registered trademark), Linux (registered trademark), iOS (registered trademark), and Android (registered trademark), for example. “Windows” is a registered trademark of Microsoft Corporation. “macOS” is a registered trademark of Apple Inc. “Linux” is a registered trademark of Linus Torvalds. “iOS” is a registered trademark of Cisco Technology Inc. “Android” is a registered trademark of Google LLC.

The general-purpose printing program 41 is implemented (or embedded) in the OS 21. The general-purpose printing program 41 is an OS-standard program prepared by the vendor of the OS 21 and provided as part of the OS 21. In other words, the OS 21 having the general-purpose printing program 41 is installed on the PC 1. The general-purpose printing program 41 is not configured to use printer drivers specific to individual printers.

The general-purpose printing program 41 functions to execute printing on a plurality of models of printers (printer models) respectively provided by a plurality of vendors on the basis of user commands. The general-purpose printing program 41 supports generic functions that allow printing to be executed on many printers. Unlike printer drivers designed for specific types of printers, the general-purpose printing program 41 does not support functions that are specific to each printer or printer driver, particularly those functions that require complex processing.

The general-purpose printing program 41 includes functions for receiving image data specified as the printing target in print instructions outputted or issued from various application programs (also described as “app(s)”) based on user commands and for generating intermediate data based on that image data. An example of intermediate data is XML Paper Specification (XPS) data. XML is an abbreviation of Extensible Markup Language. The general-purpose printing program 41 also has a function for generating print data based on intermediate data in a format that can be used for printing on various printers. An example of print data is PWG Raster data or PDF data. PWG is an abbreviation of Printer Working Group, and PDF is an abbreviation of Portable Document Format. The general-purpose printing program 41 also has a function for transmitting the generated print data to a printer designated as the device to execute printing via a communication function of the OS 21.

The auxiliary program 42 is a program or a set of programs that execute processes based on instructions from the OS 21 in conjunction with the processes of the general-purpose printing program 41 and is a program that provides control support for the target hardware. The auxiliary program 42 of the present embodiment supports the printer model of the printer 2 connected to the PC 1 and is provided by the vendor of the printer 2, for example. That is, the auxiliary program 42 corresponds to and is designed for the printer model of the printer 2. The general-purpose printing program 41 starts up the auxiliary program 42 associated with the printer 2 in the following cases including: when the printer 2 is selected as the device to execute printing; when an instruction or a command for advanced print settings is received while the printer 2 is selected; when an instruction or a command to execute printing on the printer 2 is received; and the like. To start up the auxiliary program 42, the general-purpose printing program 41 or the OS 21 may issue a start-up instruction to start up the auxiliary program 42. The auxiliary program 42 is called a Print Support Application (PSA) Program or a Hardware Support Application (HSA) Program, for example.

The auxiliary program 42 may be a combination of a plurality of programs, each of which receives execution instructions, or may be a single program that can execute different processes according to the received instructions. The vendors of printers may prepare an auxiliary program for each type of printer. For example, one auxiliary program may be prepared for inkjet printers and another auxiliary program may be prepared for laser printers. Alternatively, an auxiliary program may be prepared for each printer model or model series rather than each type of printer.

When a new printer is connected to the PC 1, for example, the OS 21 of the PC 1 can download the appropriate auxiliary program from a server of the vendor of the printer or the like based on the type or printer model of the connected printer and can install this program on the PC 1. The OS 21 stores identification information for the installed auxiliary program in the memory 12 in association with printer information on the newly connected printer.

The editing app 43 is a program used for creating and editing image data and document data, for example. Examples of the editing app 43 include Microsoft Word and Microsoft PowerPoint (registered trademark) developed by Microsoft Corporation (registered trademark), and a program provided by the vendor of the printer 2. “Microsoft” and “PowerPoint” are registered trademarks of Microsoft Corporation. The editing app 43 accepts commands via the user interface 13, such as a print execution command for instructing the printer 2 to execute printing. The editing app 43 is not limited to a program for creating and editing data but may be a program that accepts print execution commands and display commands for displaying various types of information, such as map information and web pages, in response to user requests.

As illustrated in FIG. 1, the PC 1 of the present embodiment is connected to the printer 2 via the communication interface 14. The printer 2 is a device that possesses at least a print function and a communication function. When print data is received from the PC 1 or the like, for example, the printer 2 can execute printing based on the received print data. The printer 2 may be capable of performing color printing or may only be capable of performing monochrome printing.

Default print settings for the printer 2 of the present embodiment are set and stored in nonvolatile memory of the printer 2 before the printer 2 is shipped from the factory or when the printer 2 is delivered. The default print settings may include settings related to duplex printing, paper feed trays, discharge trays, color printing, an eco mode, stored printing, a toner save mode, color balance, a special red, N-in-1 printing, and watermark printing. The default print settings include a default parameter for each setting.

The default print settings may vary by country or shipping destination. For example, while single-sided printing may be the default setting in some countries, duplex printing may be the default setting in other countries of destination that require environmentally friendly printing. The same is true for the eco mode. Further, China and Arabian countries request that the color red be customized to a preferred color balance, for example. Hence, settings using this customized red color may be set by default for those countries.

Parameters for these default print settings are stored on the printer 2 in advance and cannot be changed by user operations through a control panel or the like. When receiving an instruction to execute printing, for example, the printer 2 can accept instructions for setting (changing) the print settings to be applied to that print job via the control panel or a management device that manages the printer 2. However, the default print settings are not changed even when the print settings are changed for a print job. When the printer 2 receives an instruction via the control panel or management device to restore the default print settings, the printer 2 can read these default print settings from nonvolatile memory of the printer 2 and restore all print settings to their default parameters.

Next, steps in various processes performed on the PC 1 of the present embodiment related to printing on the printer 2 will be described. All processes other than user operations in this embodiment essentially indicate processes performed by the CPU 11 according to instructions described in the auxiliary program 42 and other programs. While the controller 10 or CPU 11 performs the various processes according to such programs as the auxiliary program 42, general-purpose printing program 41, and OS 21, the processes may be described in this specification as if they are being executed by the programs themselves. Processes performed by the CPU 11 include hardware control using the API in the OS 21. However, a detailed description of the role of the OS 21 is omitted in this specification when describing operations of the programs. Further, “acquire” is used as a concept that does not necessarily require a request.

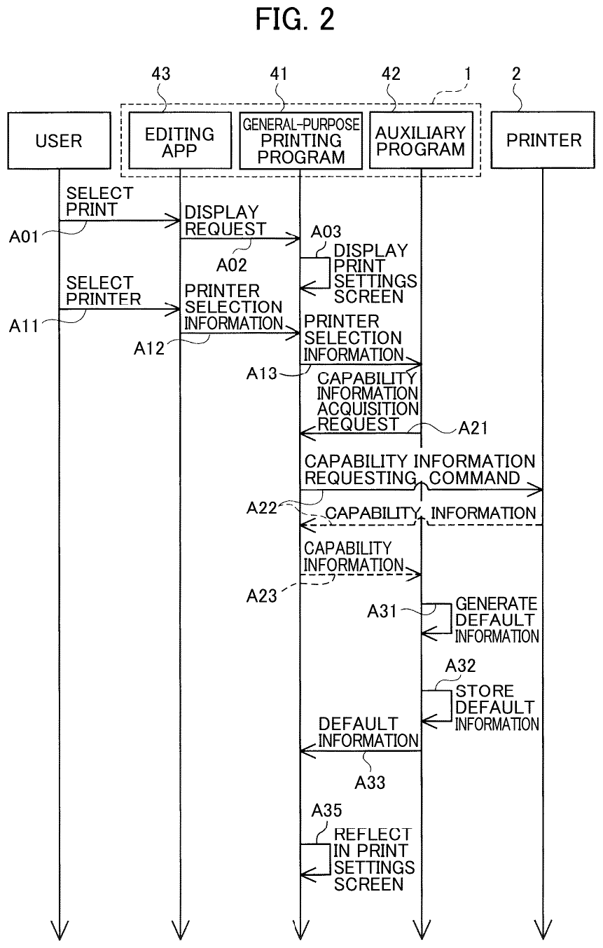

First, a printer selection procedure for accepting a user selection for a printer to be used for printing will be described with reference to the sequence chart in FIG. 2. The editing app 43 accepts user instructions to create and edit text and images based on the user instructions. When the user wishes to print the displayed text and images, in A01 the user selects “PRINT” in the editing app 43. For example, the user can select a print option from a menu of operations provided in the editing app 43.

Upon receiving a selection of “PRINT,” in A02 the editing app 43 issues a request to the general-purpose printing program 41 of the OS 21 to display a screen that accepts printing-related instructions. In response to this request, in A03 the general-purpose printing program 41 displays a print settings screen on the user interface 13. The print settings screen accepts user instructions for various print settings supported by the general-purpose printing program 41. As an alternative, the editing app 43 may display the print settings screen.

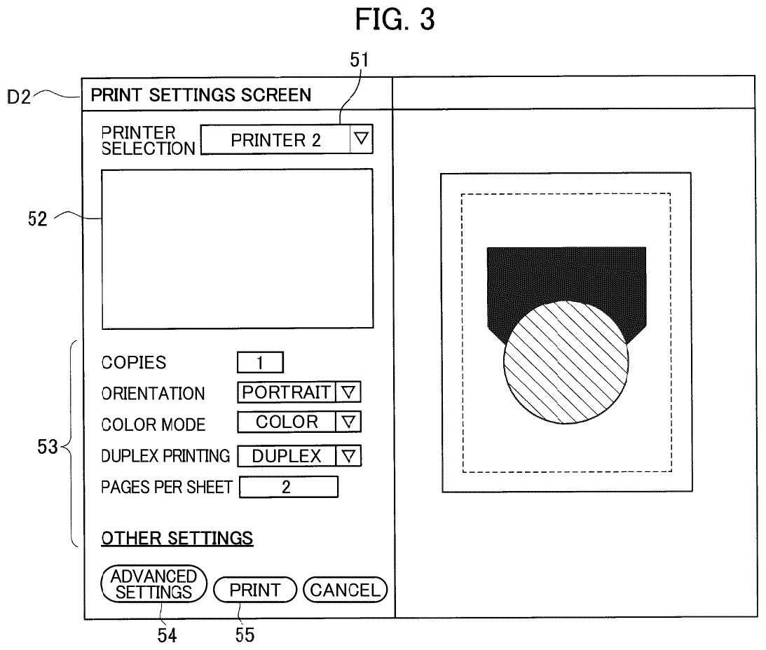

FIG. 3 illustrates an example of a print settings screen D2. The print settings screen D2 illustrated in FIG. 3 includes a printer selection field 51, an information display area 52, a print settings area 53 for selecting basic print settings, an ADVANCED SETTINGS button 54, and a PRINT button 55. The printer selection field 51 accepts a user selection for a device to execute printing. The information display area 52 displays information specified by an auxiliary program corresponding to the device selected in the printer selection field 51. For example, when the printer 2 has been selected in the printer selection field 51 or when a print instruction is received in a state where the printer 2 is set in the OS 21 as the default printer, the general-purpose printing program 41 can start up the auxiliary program 42 and display an image prepared by the auxiliary program 42 in the information display area 52.

The print settings area 53 for basic print settings accepts such basic settings as the number of copies to be printed and the orientation of the document. The ADVANCED SETTINGS button 54 accepts an instruction to perform advanced settings not included in the basic print settings area 53. The PRINT button 55 accepts a print execution command using the currently selected print settings.

When the editing app 43 receives a selection command in the printer selection field 51 selecting the printer 2 as the device to execute printing (A11) or when the editing app 43 receives a selection to print in A01 in a state where the printer 2 is selected as the device to execute printing, in A12 the editing app 43 passes information to the general-purpose printing program 41 indicating that the printer 2 has been selected (printer selection information). In A13 the general-purpose printing program 41 starts up the auxiliary program 42 that corresponds to and supports the printer 2 and passes information to the auxiliary program 42 indicating that the printer 2 has been selected (printer selection information).

When started up in response to the instruction received in A13, the auxiliary program 42 acquires capability information on the printer 2. Specifically, in A21 the auxiliary program 42 issues a request to the general-purpose printing program 41 to acquire the capability information (capability information acquisition request). In A22 the general-purpose printing program 41 transmits a command to the printer 2 requesting capability information (capability information requesting command) and subsequently acquires the capability information from the printer 2. In A23 the general-purpose printing program 41 passes the capability information acquired in A22 to the auxiliary program 42, whereby the auxiliary program 42 can acquire capability information on the printer 2. The capability information on the printer 2 includes information indicating the default print settings stored on the printer 2. The process of A23 is an example of the (a) acquiring of the present disclosure.

In A22 the general-purpose printing program 41 communicates with the printer 2 via the OS 21 according to the Internet Printing Protocol (IPP), for example. Note that rather than sending a request to the general-purpose printing program 41, the auxiliary program 42 may acquire the capability information directly from the printer 2 using a management information base (MIB), for example.

In addition to information on the default print settings, the capability information acquired from the printer 2 includes: information on parameters that can be set as print settings; information on settings related to paper feed trays available in the printer 2; information on settings related to discharge trays available in the printer 2; information indicating whether the printer 2 supports duplex printing, sorting of printed copies, and other functions; information on the supported printing resolutions; and the like. Information on settings related to paper feed trays includes: information on paper feed trays that can be selected; and information specifying sizes and types of paper that can be loaded into each paper feed tray, for example. The capability information may also include information indicating the status of the printer 2, such as information indicating whether paper is loaded in each paper feed tray, information specifying the sizes and types of paper that have been detected or set for each paper feed tray, and information on the residual quantities of consumables.

In A31 the auxiliary program 42 generates default information indicating the default print settings based on the acquired capability information. The default information includes: information specifying the parameters of settings related to paper feed trays; information on the discharge trays specified in the default print settings; information indicating whether duplex printing is set by default; information on the resolution specified by default; and the like. The parameters of settings related to paper feed trays include the paper feed trays specified in the default print settings and the information on the sizes and types of paper in paper feed trays specified in the default print settings, for example.

In A32 the auxiliary program 42 stores the default information generated in A31 in the memory 12. At this time, the auxiliary program 42 stores the default information in both the volatile memory 122 and the nonvolatile memory 121. Specifically, the auxiliary program 42 stores the default information in the volatile memory 122. The auxiliary program 42 then also generates a default information file containing the default information and stores the generated default information file in the nonvolatile memory 121. The process of A32 is an example of the (b) storing of the present disclosure. Note that the capability information may include information other than the default information, and in A32 the auxiliary program 42 may store capability information containing information other than the default information.

When default information is stored in the volatile memory 122, the auxiliary program 42 can read this default information from the volatile memory 122 more quickly than when reading the default information file from the nonvolatile memory 121. Hence, the auxiliary program 42 can access the default information quickly.

Here, the auxiliary program 42 stores the default information in an area of the volatile memory 122 that has been allocated for the current process. Areas allocated for the current process are freed once the process ends. Therefore, the default information stored in the volatile memory 122 may be erased and no longer readable once the process ends. Using the process in FIG. 2 as an example, the auxiliary program 42 can read default information stored in the volatile memory 122 while the editing app 43 is running but can no longer read this default information after the user quits the editing app 43.

On the other hand, the default information file stored in the nonvolatile memory 121 is not erased when the process ends, unless a procedure is performed to delete the file. Since the auxiliary program 42 stores this default information in the nonvolatile memory 121 as a default information file, the default information can be read from this file even when the process has ended and is performed again.

In A33 the auxiliary program 42 passes the default information to the general-purpose printing program 41. In A35 the general-purpose printing program 41 reflects the default information received from the auxiliary program 42 in the print settings screen D2 that has been displayed in A03 (see FIG. 3). The general-purpose printing program 41 may pass the default information to the editing app 43.

As described above, the print settings screen D2 includes the information display area 52 for displaying an image prepared by the auxiliary program 42. The auxiliary program 42 may prepare, for displaying in the information display area 52, information on the print settings contained in the default information. The information on the print settings will also be referred to as print settings information. When an operation is received in the print settings screen D2, the general-purpose printing program 41 can also pass information on that operation to the auxiliary program 42. For example, the auxiliary program 42 may prepare, for displaying in the information display area 52, an information screen that includes a button for receiving an instruction to restore print settings to the default values for the printer 2, and the general-purpose printing program 41 may accept a user operation on that button. When the general-purpose printing program 41 receives an operation on this button and passes information on the received operation to the auxiliary program 42, the auxiliary program 42 can read the default information stored in A32 and pass this default information to the general-purpose printing program 41 in order to reflect the default information in the currently displayed print settings screen D2.

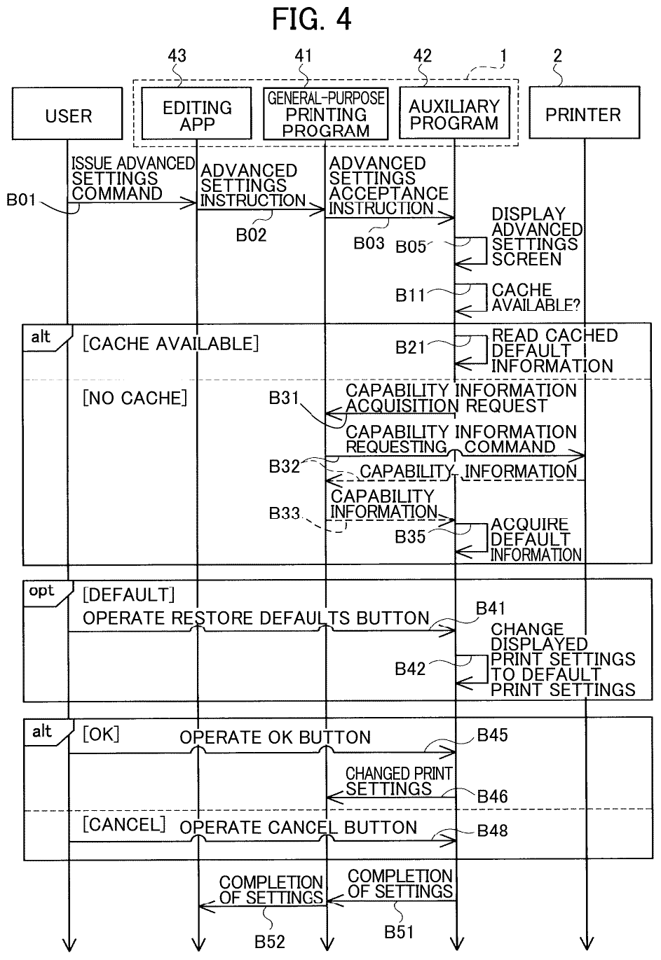

Next, a print settings configuration procedure for accepting user operations in the print settings screen D2 will be described with reference to the sequence chart in FIG. 4. At the start of the procedure in FIG. 4, the print settings screen D2 is displayed on the user interface 13 with the printer 2 selected as the device to execute printing, as illustrated in FIG. 3.

By operating the ADVANCED SETTINGS button 54 in the print settings screen D2 in B01, the user can issue a command to configure advanced print settings related to printing on the printer 2 (advanced settings command). Upon receiving an operation on the ADVANCED SETTINGS button 54, in B02 the editing app 43 outputs an advanced settings instruction, i.e., an instruction to display a settings screen for accepting advanced print settings to the general-purpose printing program 41. In B03 the general-purpose printing program 41 starts up the auxiliary program 42 corresponding to and supporting the printer 2 and passes an instruction to the auxiliary program 42 to begin accepting advanced print settings (advanced settings acceptance instruction). In B03 the general-purpose printing program 41 passes print settings information on the print settings currently set in the editing app 43 to the auxiliary program 42 together with the advanced settings acceptance instruction.

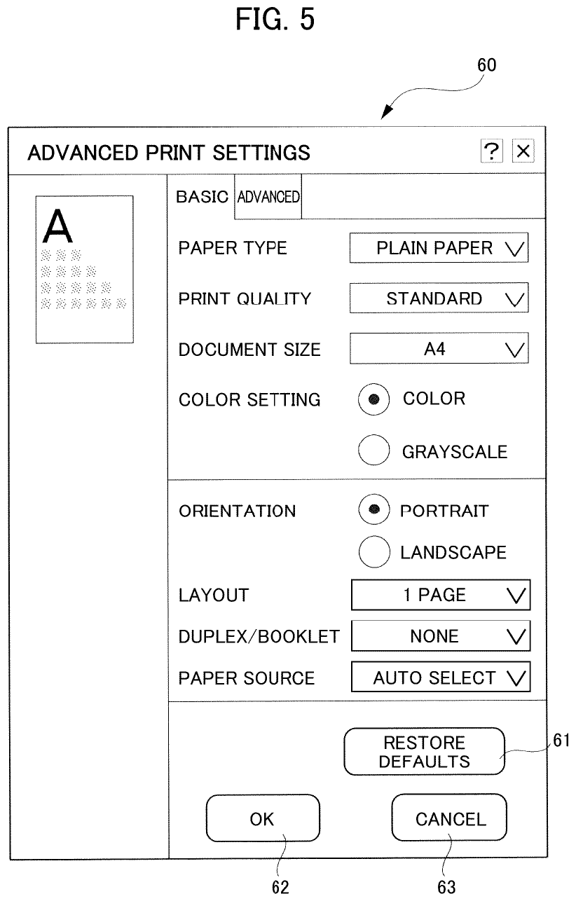

In B05 the auxiliary program 42 displays an advanced settings screen on the user interface 13 based on the print settings information received in B03 and accepts user operations in the advanced settings screen. The process of B05 is an example of the (d) displaying of the present disclosure. FIG. 5 illustrates an example of an advanced settings screen 60 displayed by the auxiliary program 42. As illustrated in FIG. 5, the advanced settings screen 60 includes a RESTORE DEFAULTS button 61 for returning settings to their default values, an OK button 62, and a CANCEL button 63. The advanced settings screen 60 can also accept various print settings. The advanced settings screen 60 is an example of the settings screen of the present disclosure and an example of the advanced print settings screen of the present disclosure. The RESTORE DEFAULTS button 61 accepts an instruction to restore all print settings to the default print settings for the printer 2 and is an example of the prescribed operation element of the present disclosure. When displaying the advanced settings screen 60 in B05, the auxiliary program 42 displays the print settings based on the print settings information passed from the general-purpose printing program 41 in a selected state.

The advanced settings screen 60 displayed by the auxiliary program 42 includes a range of parameters supported by the printer 2 for each of the print settings as options. Since there are numerous print settings that can be configured in the advanced settings screen 60, the auxiliary program 42 may have a plurality of tabs for switching the configurable settings, for example.

Once the auxiliary program 42 is started up by the instruction in B03, the auxiliary program 42 further determines in B11 whether default information has been cached. The auxiliary program 42 first determines whether default information is stored in the volatile memory 122. When the auxiliary program 42 determines that no default information is stored in the volatile memory 122, the auxiliary program 42 then determines whether default information is stored in the nonvolatile memory 121, i.e., whether a default information file exists.

When the auxiliary program 42 determines that default information is stored in either the volatile memory 122 or nonvolatile memory 121 (alt: [CACHE AVAILABLE]), in B21 the auxiliary program 42 reads the stored default information from the volatile memory 122 or nonvolatile memory 121. The process of S21 is an example of the (c) reading of the present disclosure.

In B21 the auxiliary program 42 should read only such default information that is supported by the auxiliary program 42 and displayed on the advanced settings screen 60. For example, if the printer 2 is only provided with one discharge tray, the auxiliary program 42 does not include the print setting for accepting a discharge tray selection in the advanced settings screen 60 since such a selection cannot be accepted. Thus, the auxiliary program 42 need not acquire information specifying the discharge tray setting in B21, even though the default information includes such information.

On the other hand, when the auxiliary program 42 determines that no default information is stored in either the volatile memory 122 or nonvolatile memory 121 (alt: [NO CACHE]), the auxiliary program 42 acquires capability information on the printer 2. Specifically, in B31 the auxiliary program 42 issues a request to the general-purpose printing program 41 to acquire capability information (capability information acquisition request). In B32 the general-purpose printing program 41 acquires the capability information from the printer 2, and in B33 the auxiliary program 42 receives this capability information from the general-purpose printing program 41. Steps B31 through B33 are identical to steps A21 through A23 in FIG. 2. The process of B31 through B33 is an example of the (f) acquiring of the present disclosure.

In B35 the auxiliary program 42 acquires default information to be displayed in the advanced settings screen 60 based on the capability information acquired in B33. Thus, when default information is not cached, the auxiliary program 42 acquires default information to be displayed at the timing when the auxiliary program 42 displays the advanced settings screen 60 and accepts the user operation on the ADVANCED SETTINGS button 54. As in A32 of FIG. 2 described above, the auxiliary program 42 may also store the default information in the memory 12 based on the capability information acquired in B33.

Note that when requesting the general-purpose printing program 41 to acquire capability information on the printer 2 in B31, the auxiliary program 42 may specify just some of the capability information. Specifically, the auxiliary program 42 may request capability information that includes only the information to be displayed in the advanced settings screen 60.

The auxiliary program 42 then accepts user operations in the advanced settings screen 60 displayed in B05. When an operation is received for one of the settings displayed in the advanced settings screen 60, the auxiliary program 42 changes the displayed parameter on the basis of the user operation. Here, the auxiliary program 42 copies the print settings information received in B03 and changes the copied information on the basis of user operations.

When the auxiliary program 42 receives a user operation on the RESTORE DEFAULTS button 61 in B41 (opt: [DEFAULT]), in B42 the auxiliary program 42 changes all parameters displayed in the advanced settings screen 60 to the default settings based on the default information acquired in B21 or B35 and redisplays the advanced settings screen 60 while reflecting these changed print settings. The process of S42 is an example of the (e) reflecting of the present disclosure. For example, when default information on the printer 2 includes information indicating plain paper as the paper type, standard (standard resolution) as the print quality, A4 as the document size, color as the color setting, portrait as the printing orientation, 2-in-1 as the layout, duplex printing as the duplex/booklet setting, and tray 1 as the paper source, the auxiliary program 42 reflects the default parameter for each respective setting in the advanced settings screen 60.

When default information is stored in the memory 12, the auxiliary program 42 can reflect the default print settings for the printer 2 in the advanced settings screen 60 immediately after the RESTORE DEFAULTS button 61 is operated. In other words, a user who wishes to use the default print settings stored on the printer 2 need only operate the RESTORE DEFAULTS button 61. This reduces the effort required by a user who wishes to execute printing using the default print settings.

As an alternative, the auxiliary program 42 may perform the determination in B11 after receiving an operation on the RESTORE DEFAULTS button 61 and may execute steps B31 through B33 and B35 when there is no cache. However, if default information is read when the advanced settings screen 60 is first displayed, the auxiliary program 42 can use this default information immediately after receiving an operation on the RESTORE DEFAULTS button 61. Thus, when default information is requested through an operation on the RESTORE DEFAULTS button 61, the auxiliary program 42 can quickly and easily apply the default information to the advanced settings screen 60.

To end operations in the advanced settings screen 60, the user operates the OK button 62 or CANCEL button 63. The OK button 62 accepts an instruction to confirm the displayed print settings. When the auxiliary program 42 receives an operation on the OK button 62 in B45 (alt: [OK]), in B46 the auxiliary program 42 passes print settings information on the displayed print settings to the general-purpose printing program 41, whereby the general-purpose printing program 41 can update the print settings information received by the editing app 43 with the information received through the advanced settings screen 60.

The CANCEL button 63 accepts an instruction to cancel all operations received through the advanced settings screen 60 and to maintain all print settings at their parameters prior to the advanced settings screen 60 being displayed. When the auxiliary program 42 receives an operation on the CANCEL button 63 in B48 (alt: [CANCEL]), the auxiliary program 42 discards the copy of the print settings information and does not pass any print settings information received via the advanced settings screen 60 to the general-purpose printing program 41.

In B51 the auxiliary program 42 then notifies the general-purpose printing program 41 that the advanced settings are complete. In B52 the general-purpose printing program 41 notifies the editing app 43 that the advance settings are complete. As a result, the editing app 43 displays the print settings screen D2 (see FIG. 3), while reflecting information in the print settings screen D2 based on the user operations.

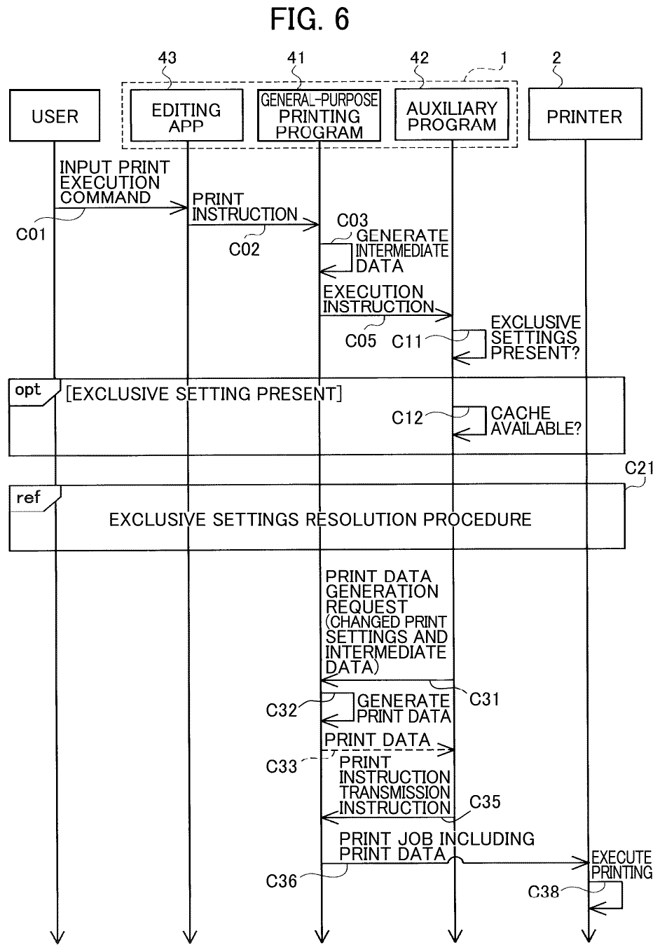

Next, a print execution procedure will be described with reference to the sequence chart in FIG. 6. After selecting the image to be printed and configuring the print settings for the printer 2, in C01 the user inputs a command in the editing app 43 to execute printing (print execution command). For example, when an operation on the PRINT button 55 is received in the print settings screen D2 illustrated in FIG. 3, the editing app 43 determines that the general-purpose printing program 41 has received a print execution command to print the selected image on the printer 2 since the general-purpose printing program 41 is embedded in the OS 21 of the PC 1.

In C02 the editing app 43 transmits a print instruction to the general-purpose printing program 41 by outputting information on the received print execution command to the general-purpose printing program 41, and the general-purpose printing program 41 acquires this information from the editing app 43. Information on the print execution command includes image data representing the image to be printed, and information specifying the print settings.

In C03 the general-purpose printing program 41 generates intermediate data based on the information acquired from the editing app 43 by converting the format of the image data representing the image to be printed to the format of the intermediate data. Since the editing app 43 contains image data of various types, the general-purpose printing program 41 converts the image data to be printed to intermediate data that is suitable for generating print data. If the image data to be printed is already suitable for generating print data, the general-purpose printing program 41 may skip the process to generate intermediate data and use the image data received from the editing app 43 as the intermediate data.

Prior to generating the intermediate data, the general-purpose printing program 41 may also start up the auxiliary program 42 corresponding to the printer 2, which is the designated device, and notify the auxiliary program 42 that processing of a print job has begun. When started up from the general-purpose printing program 41, the auxiliary program 42 can pass information specifying various instructions for use in generating intermediate data to the general-purpose printing program 41 as needed.

After generating the intermediate data, in C05 the general-purpose printing program 41 starts up the auxiliary program 42 by outputting an execution instruction to the auxiliary program 42. The auxiliary program 42 can acquire the intermediate data generated by the general-purpose printing program 41 and the print settings by sending a request to the general-purpose printing program 41, for example. The auxiliary program 42 can then edit the intermediate data and print settings information on print settings received from the general-purpose printing program 41 as needed.

In C11 the auxiliary program 42 determines whether the print settings include an exclusive setting on the basis of the acquired print settings information. The exclusive setting is a setting that contain either a parameter that cannot be selected or a set of parameters that cannot be selected at the same time. If the printer 2 receives a print job in which print settings containing an exclusive setting, an error may occur and the printer 2 may be unable to execute printing.

For some exclusive settings, the printer 2 stores information on the exclusive settings, and information on a resolution method for resolving the exclusive settings. This information related to exclusive settings may be included when outputting the capability information. Alternatively, the auxiliary program 42 may already possess information related to exclusive settings in the printer 2, and acquire this information from the capability information on the printer 2.

When the auxiliary program 42 determines that the print settings contain an exclusive setting (opt: [EXCLUSIVE SETTING PRESENT]), in C12 the auxiliary program 42 determines whether default information has been stored. The process of C12 is identical to the process of B11 in FIG. 4. In C21 the auxiliary program 42 executes a procedure for resolving the exclusive settings based on the determinations in C11 and C12.

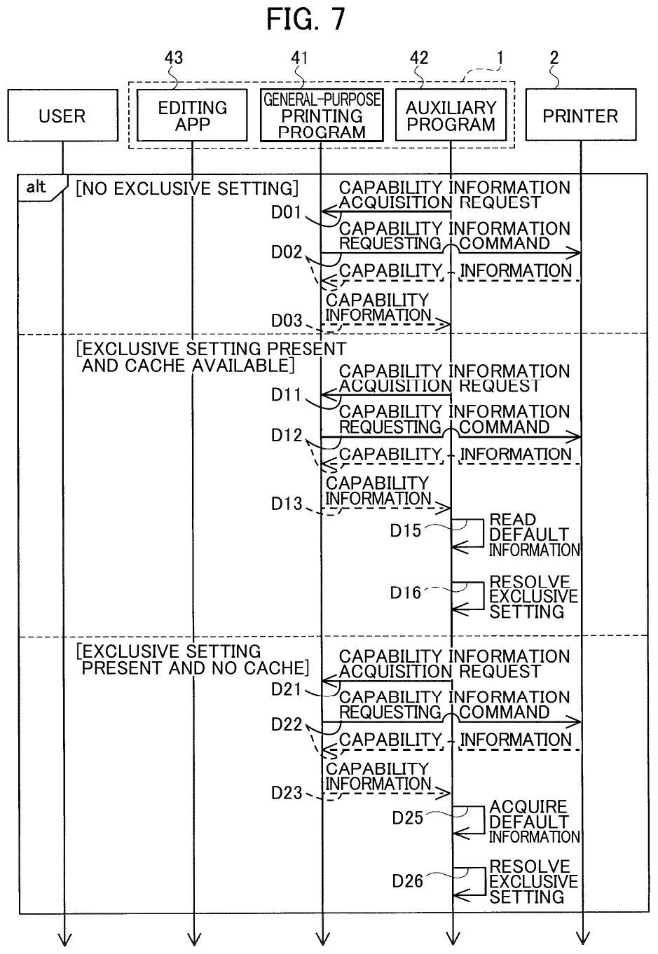

A procedure executed in C21 for resolving exclusive settings (exclusive settings resolution procedure) will be described with reference to the sequence chart in FIG. 7. When the auxiliary program 42 has determined in C11 of FIG. 6 that the print settings do not contain exclusive settings (alt: [NO EXCLUSIVE SETTING]), in D01 of FIG. 7 the auxiliary program 42 sends a request to the general-purpose printing program 41 to acquire capability information on the printer 2 (capability information acquisition request). In D02 the general-purpose printing program 41 acquires the capability information from the printer 2, and in D03 the auxiliary program 42 acquires this capability information from the general-purpose printing program 41. This process differs from A21 through A23 in FIG. 2 in that in D01 the auxiliary program 42 only requests that the general-purpose printing program 41 acquire information essential for executing the print. In other words, the amount of information requested in D01 is less than that in A21 and, hence, the time required to complete the process in D01 through D03 is shorter than the time required to complete A21 through A23.

On the other hand, when the auxiliary program 42 determines in C11 of FIG. 6 that the print settings contain an exclusive setting and determines in C12 that default information has been stored (alt: [EXCLUSIVE SETTING PRESENT AND CACHE AVAILABLE]), in D11 of FIG. 7 the auxiliary program 42 sends a request to the general-purpose printing program 41 to acquire capability information from the printer 2 (capability information acquisition request). In D12 the general-purpose printing program 41 acquires the capability information from the printer 2, and in D13 the auxiliary program 42 acquires this capability information from the general-purpose printing program 41. In D11 through D13 the auxiliary program 42 need not acquire the default information anew but only need acquire information essential to execute printing.

In D15 the auxiliary program 42 reads the default information stored in the memory 12. In D16 the auxiliary program 42 changes the print settings to resolve the exclusive setting determined in C11 of FIG. 6 to be included in the print settings. The process of D16 is an example of the (h) changing of the present disclosure.

There are various types of exclusive settings, some of which have information on a resolution method (resolution method information) included in the capability information on the printer 2 and others that do not. When the exclusive setting determined in C11 of FIG. 6 to be included in the print settings can be resolved according to the resolution method information included in the capability information stored in the memory 12, in D16 the auxiliary program 42 resolves the setting on the basis of the resolution method information. However, when the exclusive setting determined in C11 of FIG. 6 to be included in the print settings cannot be resolved according to the resolution method information, in D16 the auxiliary program 42 changes each print setting determined to be exclusive to their respective default print setting on the basis of the default information stored in the memory 12.

When print settings received with an execution instruction contain an exclusive setting that cannot be selected, the auxiliary program 42 reads resolution method information and default information stored in the memory 12 when the printer was selected and uses the read resolution method information and default information to change the exclusive setting to a print setting that resolve this problem. Through this process, the auxiliary program 42 can avoid sending a print job containing exclusive settings to the printer 2. Note that the auxiliary program 42 may also resolve exclusive settings using only the default information and not the resolution method information.

Further, when the auxiliary program 42 determines in C11 of FIG. 6 that the print settings contain an exclusive setting and determines in C12 of FIG. 6 that default information has not been stored (alt: EXCLUSIVE SETTING PRESENT AND NO CACHE), in D21 of FIG. 7 the auxiliary program 42 sends a request to the general-purpose printing program 41 to acquire capability information from the printer 2 (capability information acquisition request). In D22 the general-purpose printing program 41 acquires the capability information from the printer 2, and in D23 the auxiliary program 42 acquires this capability information from the general-purpose printing program 41. Similar to B31 through B33 of FIG. 4, in D21 through D23 the auxiliary program 42 requests and acquires more capability information than that requested and acquired in D01 through D03 and D11 through D13 of FIG. 7. In D21 through D23 the auxiliary program 42 may also request and acquire all the capability information, as in A21 through A23 of FIG. 2. The process of D21 through D23 is an example of the (i) acquiring of the present disclosure.

In D25 the auxiliary program 42 further acquires resolution method information and default information based on the acquired capability information. In D26 the auxiliary program 42 uses the acquired resolution method information and default information to change the print settings in order to resolve the exclusive setting determined in C11 of FIG. 6 to be included in the print settings. The process of D26 is an example of the (h) changing of the present disclosure. Note that the auxiliary program 42 may also resolve the exclusive settings using only the default information and not the resolution method information.

Since the auxiliary program 42 acquires capability information at this time to acquire resolution method information and default information when such default information has not been stored, the auxiliary program 42 will likely be able to resolve exclusive settings using the acquired information. For example, when the auxiliary program 42 cannot resolve exclusive settings using the resolution method information, the auxiliary program 42 will likely be able to resolve these settings using the default print settings on the printer 2. The auxiliary program 42 may also store the default information acquired in D25 in the memory 12.

Returning to the description of the print execution procedure in FIG. 6, once the exclusive settings have been resolved, in C31 the auxiliary program 42 passes the changed print settings and the intermediate data to the general-purpose printing program 41 and sends a request to the general-purpose printing program 41 to generate print data (print data generation request). In C32 the general-purpose printing program 41 rasterizes the intermediate data to generate print data containing raster data, which is bitmap data. In C33 the general-purpose printing program 41 passes the generated print data to the auxiliary program 42.

In C35 the auxiliary program 42 sends an instruction to the general-purpose printing program 41 to transmit a print instruction to the printer 2 by passing the print data to the general-purpose printing program 41 (print instruction transmission instruction). The process of C35 causes the printer 2 to execute printing and is an example of the (g) causing of the present disclosure. In C36 the general-purpose printing program 41 transmits a print job including the print data to the printer 2. In C38 the printer 2 executes printing based on the print data received from the general-purpose printing program 41, thereby producing printed matter based on the print instruction outputted from the editing app 43.

The auxiliary program 42 may also perform the rasterization in place of the general-purpose printing program 41. In this case, the auxiliary program 42 rasterizes the intermediate data received in the execution instruction to generate raster data. The auxiliary program 42 has a greater degree of freedom for rasterizing intermediate data than the general-purpose printing program 41 and is more likely to generate raster data that is suitable for printing on the printer 2. On the other hand, performing rasterization with the general-purpose printing program 41 can reduce the processing load on the auxiliary program 42 and can reduce the size of the auxiliary program 42 itself.

Furthermore, the auxiliary program 42 may acquire raster data generated by the general-purpose printing program 41 or the auxiliary program 42 itself and may process this data as needed. For example, the auxiliary program 42 may generate print data by encoding the raster data as PDL data suitable for the printer 2. PDL is an abbreviation of Page Description Language. The PDL data generated by the auxiliary program 42 may be in a format that can be used for printing on printers other than the printer model of the printer 2.

While the general-purpose printing program 41 transmits a print job to the printer 2 in the above example, the auxiliary program 42 may instead transmit the print data to the printer 2 together with a print command instructing the printer 2 to execute printing. Furthermore, when the print settings include settings for an image process that can be executed on the printer 2, for example, the auxiliary program 42 may generate a print command that includes information on this process. In this case, the auxiliary program 42 may notify the general-purpose printing program 41 that the process has ended after the transmission of print data is complete.

As described above in detail, the auxiliary program 42 of the present embodiment controls the CPU 11 of the PC 1 to acquire default print settings stored on the printer 2 and to store default information in the memory 12 when the printer 2 has been selected in the editing app 43. The auxiliary program 42 also controls the CPU 11 to read default information stored in the memory 12 when using the default print settings for the printer 2. In this way, it is highly likely that the default print settings stored on the printer 2 can be used immediately. Furthermore, by having the CPU 11 store default information when the printer 2 is selected, the auxiliary program 42 can respond to any changes in default information for the printer 2 after the initial startup.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. For example, a device connected to the PC 1 is not limited to the printer 2, but may be any device having a printing function, such as a multifunction peripheral, copier machine, and facsimile machine. The number of devices (printers 2) connected to the PC 1 is not limited to that illustrated in the drawings, but may be two or more.

Furthermore, the screens displayed on the user interface 13 in this specification are merely examples and are not limited to the examples illustrated in the drawings. The wordings, shapes of objects, backgrounds, and the like depicted in these screens may be of any types. Furthermore, while FIG. 3 illustrates one example of a print settings screen D2 that includes a single information display area 52, the arrangement, shape, size, number, and the like of the information display areas 52 are not limited to this example. Alternatively, the information display area 52 may be eliminated.

In the print settings configuration procedure illustrated in FIG. 4, the auxiliary program 42 determines whether a cache is available after displaying the advanced settings screen 60 in B05 and acquires capability information on the printer 2 when a cache does not exist, but the timing for determining whether a cache exists and the timing for acquiring the capability information are not limited to these timings. For example, the auxiliary program 42 may just determine whether a cache exists following step B05 and may acquire the capability information when no cache exists once an operation is received on the RESTORE DEFAULTS button 61. The auxiliary program 42 may also determine whether a cache exists only after an operation is received on the RESTORE DEFAULTS button 61.

When print settings in a print instruction or an execution instruction contain an exclusive setting in this specification, the auxiliary program 42 resolves this exclusive setting on the basis of the default information (D16, D26). However, the auxiliary program 42 may instead notify the user of this exclusivity and prompt the user to change the print settings. Alternatively, the auxiliary program 42 may change the parameters of all print settings to their default print settings when the print settings contain an exclusive setting.

In this specification, the auxiliary program 42 stores default information in both the volatile memory 122 and nonvolatile memory 121, but the auxiliary program 42 may instead store default information in only one of these memories.

The general-purpose printing program 41 may also start up the auxiliary program 42 when the printer normally used is changed to the printer 2 from another printer via the OS 21 in response to a user operation after the print settings screen D2 is displayed by the general-purpose printing program 41. The auxiliary program 42 may also be started up when the printer 2 is selected as the device setting, for example, and not just when “PRINT” is selected. In these cases, the auxiliary program 42 may also display a settings screen that includes an operation element that accepts an instruction or a command to apply the default print settings.

In the embodiment described above, only printing operations have been described in detail as the operations of the auxiliary program 42, but the auxiliary program 42 may have other roles. Further, the program that executes the processes described in the embodiment is not limited to the auxiliary program 42 but may be another program that receives instructions from the OS 21 or the general-purpose printing program 41 when printing is performed using the general-purpose printing program 41. For example, a print workflow application program having specifications published by Microsoft Corporation may be used as the program.

The execution timing of the auxiliary program 42 is not limited to the examples in the embodiment. For example, the auxiliary program 42 may be executed in response to execution instructions received directly from the OS 21. Alternatively, the auxiliary program 42 may be a resident program, in which case the auxiliary program may perform the operations described above upon receiving an execution command.

In any of the sequence charts disclosed in the embodiment, the plurality of processes that make up any of the plurality of steps may be executed in parallel, or the order in which the processes are performed may be modified in any way that does not produce any inconsistencies in the processes.

The processes disclosed in the embodiment may be executed by a single CPU, a plurality of CPUs, an ASIC or other hardware, or a combination of these components. Further, the processes disclosed in the embodiment may be achieved through a storage medium that stores the programs used to implement those processes or according to any of various other methods or formats.

What is claimed is:

1. A non-transitory computer-readable storage medium storing a support program for an information processing device communicable with a printer, the information processing device including: a computer; and a memory configured to store therein an editing application program and an operating system in which a general-purpose printing program is embedded, the support program corresponding to the printer and supporting the general-purpose printing program, the support program, when executed by the computer, causing the information processing device to perform:
when a selection instruction selecting the printer is issued from the editing application program to the general-purpose printing program:
(a) acquiring, from the printer, a default print setting stored on the printer; and
(b) storing, as a cache default print setting, the default print setting acquired in the (a) acquiring in the memory; and
when using the default print setting:
(c) reading, from the memory, the cache default print setting stored in the (b) storing.

2. The non-transitory computer-readable storage medium according to claim 1,
wherein the support program, when executed by the computer, causes the information processing device to further perform:
(d) displaying, through a user interface of the information processing device, a settings screen for accepting a print setting to be used for printing on the printer, the settings screen including a prescribed operation element; and
when an operation on the prescribed operation element is received, (e) reflecting, in the settings screen, the cache default print setting read in the (c) reading.

3. The non-transitory computer-readable storage medium according to claim 2,
wherein the support program, when executed by the computer, causes the information processing device to perform:
when a display instruction instructing the general-purpose printing program to display the settings screen is issued from the editing application program, the (d) displaying,
wherein the (d) displaying displays an advanced print settings screen as the settings screen, the support program having the advanced print settings screen, and
wherein the (e) reflecting reflects, in the advanced print settings screen, the cache default print setting read in the (c) reading.

4. The non-transitory computer-readable storage medium according to claim 3,
wherein the support program, when executed by the computer, causes the information processing device to perform:
in response to the (d) displaying first displaying the advanced print settings screen, the (c) reading.

5. The non-transitory computer-readable storage medium according to claim 4,
wherein the support program, when executed by the computer, causes the information processing device to perform:
when the (d) displaying first displays the advanced print settings screen:
in response to determining that the cache default print setting is stored in the memory, the (c) reading;
in response to determining that the cache default print setting is not stored in the memory, (f) acquiring, from the printer selected as a device to execute printing, the default print setting stored on the printer without performing the (c) reading.

6. The non-transitory computer-readable storage medium according to claim 1,
wherein the support program, when executed by the computer, causes the information processing device to further perform:
when a print instruction instructing the general-purpose printing program to cause the printer to execute printing is issued from the editing application program:
(g) causing the printer to execute printing using print data representing an image to be printed and a print setting based on the print instruction.

7. The non-transitory computer-readable storage medium according to claim 6,
wherein the support program, when executed by the computer, causes the information processing device to perform:
when the print setting based on the print instruction includes an unconfigurable parameter:
the (c) reading;
(h) changing, using the default print setting read in the (c) reading, the print setting based on the print instruction to a changed print setting not including the unconfigurable parameter; and
the (g) causing the printer to execute printing using the changed print setting.

8. The non-transitory computer-readable storage medium according to claim 7,
wherein the support program, when executed by the computer, causes the information processing device to perform:
when the print setting based on the print instruction includes an unconfigurable parameter:
in response to determining that the cache default print setting is stored in the memory:
the (c) reading; and
the (h) changing; and
in response to determining that the cache default print setting is not stored in the memory:
(i) acquiring, from the printer designated by the print instruction, the default print setting stored on the printer without performing the (c) reading; and
the (h) changing, using the default print setting acquired in the (i) acquiring, the print setting based on the print instruction to a changed print setting not including the unconfigurable parameter.

9. The non-transitory computer-readable storage medium according to claim 1,
wherein the default print setting acquired in the (a) acquiring includes a setting related to a tray of the printer.

10. The non-transitory computer-readable storage medium according to claim 1,
wherein the memory of the information processing device includes a volatile memory and a nonvolatile memory,
wherein the (b) storing stores, as the cache default print setting, the default print setting acquired in the (a) acquiring in the volatile memory and generates a file in which the default print setting acquired in the (a) acquiring is written as the cache default print setting to store the file in the nonvolatile memory, the cache default print setting stored in the volatile memory being held while a process executing the (b) storing remains active and being erased when the process ends, the file stored in the nonvolatile memory being held even when the process ends, and
wherein the (c) reading reads the cache default print setting from the volatile memory when the cache default print setting is stored in the volatile memory, and reads the file from the nonvolatile memory when the cache default print setting is not stored in the volatile memory but the file is stored in the nonvolatile memory.
